(19) United States
(12) Patent Application Publication
(10) Pub. No.: US 2024/0270629 A1
(43) Pub. Date: Aug. 15, 2024

(54) GLASS FIBER AND COMPOSITION FOR GLASS FIBERS

(71) Applicant: Nippon Sheet Glass Company, Limited, Tokyo (JP)

(72) Inventor: Aya NAKAMURA, Mie (JP)

(21) Appl. No.: 18/553,812

(22) PCT Filed: Aug. 4, 2022
(86) PCT No.: PCT/JP2022/030028

§ 371 Date: Oct. 3, 2023

(30) Foreign Application Priority Data
May 31, 2022 (JP) 2022-088851

(51) Int. Cl. C03C 13/00; C03C 10/00

(52) U.S. Cl. CPC C03C 13/006; C03C 10/0045; C03C 10/0054; C03C 2204/00; C03C 2213/00

(57) ABSTRACT

The present disclosure provides a glass fiber having a fiber diameter of 18 μm or less and including a glass composition. A MgO content in the glass composition is 15 mol % or more, and a common logarithm log η of a viscosity η [dPa·s] of the glass composition at a devitrification temperature is 2.6 or more. The present disclosure also provides a glass composition which includes, in mol %: SiO₂ 50 to 65%; Al₂O₃ 5 to 26%; B₂O₃ 0 to 1.6%; MgO 15 to 30%; CaO 0 to 8%; Li₂O 0 to 2.4%; and Na₂O more than 0.2% and 2.85% or less and in which a sum of a Li₂O content, a Na₂O content, a K₂O content is 0.3 to 3.0%, and a ratio of the Na₂O content to this sum is 0.2 or more and 0.95 or less.

### TECHNICAL FIELD

The present invention relates to a glass fiber and a glass composition suitable for glass fibers.

### BACKGROUND ART

Although many of glass fibers in practical use are made of glass compositions having a Young's modulus of 90 GPa or less, glass compositions having a Young's modulus of more than 90 GPa are also known. For example, Patent Literature 1 discloses a glass composition including a large amount of rare-earth oxides. The sum of the Y₂O₃ content and the La₂O₃ content in the glass composition of Patent Literature 1 is in the range of 20 to 60 weight %. However, a high rare-earth oxide content increases manufacturing cost. Taking this into account, Patent Literature 2 discloses a technique by which the Young's modulus of a glass composition is improved without a large amount of rare-earth oxides. The glass composition of Patent Literature 2 includes 15 to 30% MgO in mol % as a component for improving the Young's modulus.

### CITATION LIST

### Patent Literature

Patent Literature 1: WO 2006/057405 A1
Patent Literature 2: JP 6391875 B1

### SUMMARY OF INVENTION

### Technical Problem

It is difficult to spin a glass fiber having a small fiber diameter out of a glass composition containing 15 mol % or more MgO (referred to as “high-Mg glass” in this paragraph) as a component for improving Young's modulus. Even a high-Mg glass capable of being spun into a glass fiber having a relatively large fiber diameter causes a lot of manufacturing troubles when spun into a glass fiber having a small fiber diameter. A high-Mg glass is likely to experience devitrification within a nozzle for spinning a small-diameter glass fiber. It is therefore an object of the present invention to provide a new glass fiber having a high Young's modulus and a relatively small diameter. Another object of the present invention is to provide a glass composition suitable for glass fibers having a high Young's modulus and a relatively small diameter.

### Solution to Problem

The present inventor conducted intensive studies on a devitrification mechanism in spinning a glass composition in which the MgO content is high, and have completed the present invention.

The present invention provides a glass fiber having a fiber diameter of 18 μm or less, the glass fiber including a glass composition, wherein
a MgO content in the glass composition is 15% or more in mol %, and
a common logarithm log η of a viscosity η [dPa·s] of the glass composition at a devitrification temperature is 2.6 or more.

In another aspect, the present invention provides a glass composition for glass fibers, the glass composition including, in mol %:
SiO₂ 50 to 65%;
Al₂O₃ 5 to 26%;
B₂O₃ 0 to 1.6%;
MgO 15 to 30%;
CaO 0 to 8%;
Li₂O 0 to 2.4%; and
Na₂O more than 0.2% and 2.85% or less, wherein
a sum of a Li₂O content, a Na₂O content, and a K₂O content is 0.3 to 3.0%, and
a Na₂O ratio defined by a ratio of the Na₂O content to the sum of the Li₂O content, the Na₂O content, and the K₂O content is 0.2 or more and 0.95 or less.

In yet another aspect, the present invention provides a glass composition for glass fibers, including, in mol %:
SiO₂ 50 to 65%;
Al₂O₃ 5 to 26%;
B₂O₃ 0 to 1.6%;
MgO 15 to 30%;
CaO 0 to 8%;
Li₂O 0% or more and less than 3%; and
Na₂O more than 0.2% and less than 3%, wherein
a common logarithm log η of a viscosity η [dPa·s] at a devitrification temperature is 2.6 or more.

In yet another aspect, the present invention provides a glass composition for glass fibers, wherein
a Young's modulus is 93 GPa or more,
a sum of a Li₂O content, a Na₂O content, and a K₂O content is 0.3 to 3.0% in mol %, and
a Na₂O ratio defined by a ratio of the Na₂O content to the sum of the Li₂O content, the Na₂O content, and the K₂O content is 0.2 or more and 0.95 or less in mol %.

### Advantageous Effects of Invention

The present invention provides a new glass fiber having a high Young's modulus and a relatively small diameter. The present invention provides a new glass composition suitable for glass fibers having a high Young's modulus and a relatively small diameter.

### DESCRIPTION OF EMBODIMENTS

Embodiments of the present invention will be described hereinafter. The following description is not intended to limit the present invention to particular embodiments. Herein, the content of every component in a glass composition below is in mol %, and mol % is basically represented by “%”. Herein, being “substantially free of” a component means that the content of the component is less than 0.1 mol %, less than 0.05 mol %, less than 0.01 mol %, less than 0.005 mol %, even less than 0.003 mol %, or, in some cases, less than 0.001 mol %. The adverb “substantially” is intended to mean that a small amount of impurities such as those derived from glass raw materials, a manufacturing apparatus, and the like may be contained. The term “alkali metal oxides” means Li₂O, Na₂O, and K₂O, and is sometimes referred to as R₂O. The upper and lower limits of each of the following contents can be arbitrarily combined.

### [Glass Fiber]

In one embodiment of the present invention, a glass fiber has a fiber diameter of 18 μm or less. This glass fiber includes a glass composition. A MgO content in the glass composition is 15% or more. A common logarithm log η of a viscosity η [dPa·s] of the glass composition at a devitrification temperature is 2.6 or more. An example of this glass composition will be described later.

A glass fiber according to another embodiment of the present invention includes the later-described glass composition. This glass fiber may have a fiber diameter of 18 μm or less, too.

The glass fiber (hereinafter referred to as “the glass fiber of the present embodiment”) of each of these embodiments may have a fiber diameter of 15 μm or less, 13 μm or less, 11 μm or less, 10 μm or less, 9 μm or less, or even 7 μm or less. Because the glass fiber of the present embodiment can have a high Young's modulus, the glass fiber of the present embodiment can exhibit a high reinforcing ability even with a small diameter. Therefore, the glass fiber of the present embodiment is particularly suitable for use in thin reinforced materials, such as thin glass-fiber-reinforced plastics (FRPs). However, articles that can include the glass fiber of the present embodiment are not limited to FRPs, and the thicknesses of such articles are not limited. The lower limit of the fiber diameter of the glass fiber of the present embodiment is not limited to a particular one, and may be 3 μm or more, or even 7 μm or more. The glass fiber of the present embodiment can have a high Young's modulus and a small diameter, but may have a diameter that is not excessively small, such as a diameter in the range of 7 to 15 μm, or even 9 to 13 μm.

The glass fiber of the present embodiment may include, in addition to the glass composition, any of various known treatment agents, resins, and other components as appropriate according to the application of the glass fiber.

### [Glass Composition]

### <Components>

Components that can be included in the glass composition will be described hereinafter.

### (SiO₂)

SiO₂ is a component that forms a glass network, and is also a component that adjusts the devitrification temperature and the viscosity during glass forming and that improves the acid resistance. A SiO₂ content is, for example, 50 to 65%. The lower limit of the SiO₂ content is, for example, 52% or more, 54% or more, 55% or more, 56% or more, 57% or more, 57.5% or more, in some cases, 58% or more, or even 59% or more. The upper limit of the SiO₂ content is, for example, 63% or less, 62% or less, or, in some cases, 61% or less.

(Al₂O₃)

Al₂O₃ is a component that adjusts the devitrification temperature and the viscosity during glass forming and that improves the water resistance of the resulting glass. An Al₂O₃ content is, for example, 5 to 26%. The lower limit of the Al₂O₃ content is, for example, 7.5% or more, 8% or more, 9% or more, 10% or more, 10.5% or more, 11% or more, 12% or more, in some cases, 12.5% or more, or even 13% or more. The upper limit of the Al₂O₃ content is, for example, 20% or less, 18% or less, 17.5% or less, 16% or less, or, in some cases, 15% or less.

### (MgO)

MgO is a component that improves the Young's modulus and that affects the devitrification temperature, the viscosity, and the like. A MgO content is, for example, 15 to 30%. The lower limit of the MgO content is, for example, 16% or more, 17.5% or more, 18% or more, 20% or more, 22% or more, in some cases, 23% or more, or even 24% or more. The upper limit of the MgO content is, for example, 27% or less, 26% or less, or, in some cases, 25% or less.

The SiO₂ content, the Al₂O₃ content, and the MgO content can be set, as described above, by combining the above upper and lower limits. The ranges thereof are desirably as follows.
Example 1: SiO₂ 52 to 62% and Al₂O₃ 7.5 to 26%
Example 2: In Example 1, Al₂O₃ 9 to 26%
Example 3: In Example 2, SiO₂ 55 to 62%
   Al₂O₃ 10.5 to 17.5%
   MgO 17.5 to 30%
Example 4: In Example 3, Al₂O₃ 11 to 17.5%
   MgO 20 to 30%

However, the above ranges are just examples, and the contents of the components are not limited to those in Examples 1 to 4 and can be set to other values.

SiO₂, Al₂O₃, and MgO are components that are important in making a practical glass composition having a high Young's modulus. A sum of the contents of these components may be more than 90%, 91% or more, or even 92% or more. The sum of the SiO₂ content, the Al₂O₃ content, and the MgO content may be, for example, 98.5% or less, or even 98% or less. When the sum of the contents is reduced as low as the above, the properties of the glass composition are adjustable in a wider range by addition of another component.

The glass composition of the present embodiment preferably further includes CaO and/or the alkali metal oxides. A glass composition in which the MgO content is high tends to have too low a viscosity η at the devitrification temperature. However, this viscosity can be adjusted by addition of CaO and the alkali metal oxides. A sum of a CaO content and a total alkali metal oxide content is, for example, 0.1% or more, 0.5% or more, 1.0% or more, or even 1.5% or more.

### (CaO)

CaO is a component that adjusts the devitrification temperature and the viscosity during glass forming. The CaO content is, for example, 0 to 8%. The lower limit of the CaO content is, for example, 0.1% or more, 0.5% or more, 0.7% or more, 1% or more, in some cases, 2% or more, or even 3% or more. The upper limit of the CaO content is, for example, 6% or less, 5.5% or less, 5% or less, or even 4% or less.

### (Alkali Metal Oxides)

The alkali metal oxides (R₂O) are components that adjust the devitrification temperature and the viscosity during glass forming. The total alkali metal oxide content, specifically, Li₂O+Na₂O+K₂O, is, for example, 0.3 to 3.0%. The lower limit of the total alkali metal oxide content is, for example, 0.5% or more, 0.7% or more, or even 0.8% or more, or, in some cases, 1.0% or more. The upper limit of the total alkali metal oxide content is, for example, 2.5% or less, 2.0% or less, 1.8% or less, 1.5% or less, in some cases, or less than 1.1%. A high total alkali metal oxide content can sometimes prevent a sufficient increase in Young's modulus.

A Na₂O content is, for example, more than 0.2% and less than 3%, or is, for example, more than 0.2% and 2.85% or less. The lower limit of the Na₂O content is, for example, 0.25% or more, 0.3% or more, 0.4% or more, or even 0.5% or more. The upper limit of the Na₂O content is, for example, 2.5% or less, 2.0% or less, 1.5% or less, 1.0% or less, 0.8% or less, in some cases, 0.6% or less, or even 0.55% or less.

The glass composition does not need to include both Li₂O and K₂O, but preferably includes at least one of them. A sum of a Li₂O content and a K₂O content is preferably 0.1% or more.

The Li₂O content is, for example, 0 to 3%, or is, for example, 0 to 2.4%. The lower limit of the Li₂O content is, for example, 0.1% or more, 0.2% or more, or, in some cases, 0.3% or more. The upper limit of the Li₂O content is, for example, 2.0% or less, 1.5% or less, 1.0% or less, 0.8% or less, in some cases, 0.6% or less, 0.5% or less, or even 0.4% or less. A preferred example of the Li₂O content is 0.1 to 0.8%.

Li₂O has an advantage over Na₂O and K₂O in that both reduction of a Young's modulus decreasing effect and adjustment of properties such as the devitrification temperature are achieved. Therefore, in the case where, for example, 0.3% or more alkali oxides are added to a glass composition designed to achieve a high Young's modulus, the Li₂O content is generally adjusted to be higher than the Na₂O content and the K₂O content. For example, in the examples of Patent Literature 2, in the case where the total alkali metal oxide content is 0.3% or more, Li₂O is added such that the Li₂O content is higher than the Na₂O content and the K₂O content by 0.45% or more.

However, for effective control of the viscosity at the devitrification temperature, priority is desirably given to appropriate control of a later-described Na₂O ratio. In addition, the raw material of Li₂O is relatively expensive compared to those of the other alkali metal oxides. Taking these into account, a small amount of Li₂O may be included such that the Li₂O content is equal to or less than the Na₂O content plus 2%. A small amount of Li₂O may be included such that the Li₂O content does not exceed the Na₂O content.

The K₂O content is, for example, 0 to 2.4%. The lower limit of the K₂O content is, for example, 0.01% or more, even 0.02% or more, or, in some cases, 0.05% or more. The upper limit of the K₂O content is, for example, 1.0% or less, 0.5% or less, 0.2% or less, or, in some cases, 0.1% or less. K₂O has a greater Young's modulus decreasing effect than Li₂O and Na₂O. The K₂O content is preferably smaller than the Li₂O content and the Na₂O content. The glass component may be substantially free of K₂O.

The relative magnitude relations, described in the above two paragraphs, between the alkali metal oxides can be translated as follows. The Li₂O content (mol %), the Na₂O content (mol %), and the K₂O content (mol %) are respectively expressed as [Li₂O], [Na₂O], and [K₂O]. The alkali metal oxides are preferably included to be within at least one of the following ranges.

$$\begin{matrix}0 < [ L {i}_{2} O ] \leq ( [ N {a}_{2} O ] + 2 ) \\ 0 < [ L {i}_{2} O ] \leq [ N {a}_{2} O ] \\ [ {K}_{2} O ] < [ N {a}_{2} O ] \\ [ {K}_{2} O ] < [ L {i}_{2} O ]\end{matrix}$$

When the total R₂O content is 0.3% or more, more specifically 0.3 to 3.0%, a ratio of the Na₂O content to the R₂O content ([R₂O]/[Na₂O] according to the above notation) (the ratio can be hereinafter also referred to as “Na₂O ratio”) is preferably 0.2 or more and 0.95 or less. The spinning capability of a glass composition in which the MgO content is high is improved by adjusting the Na₂O ratio within the appropriate range. The lower limit of the Na₂O ratio may be, for example, 0.22 or more, 0.27 or more, or even 0.3 or more. The upper limit of the Na₂O ratio is, for example, 0.92 or less, 0.86 or less, 0.8 or less, 0.78 or less, 0.73 or less, or, in some cases, 0.7 or less. An appropriate adjustment of the Na₂O ratio makes it possible to achieve a desired effect, such as a sufficient increase in log η, by addition of a limited amount of the alkali metal oxides.

That is, the following are preferably established, where the total alkali metal oxide content (mol %) is expressed as [R₂O].

$$\begin{matrix}0.3 \leq [ {R}_{2} O ] \leq 3.0 \\ 0.2 \leq ( [ N {a}_{2} O ] / [ {R}_{2} O ] ) \leq 0.95\end{matrix}$$

(B₂O₃)

B₂O₃ is a component that forms a glass network and is also a component that adjusts the devitrification temperature and the viscosity during glass forming. A B₂O₃ content is, for example, 0 to 1.6%. The lower limit of the B₂O₃ content is, for example, 0.1% or more, 0.5% or more, or, in some cases, 1.0% or more. The upper limit of the B₂O₃ content is, for example, less than 1.5%, or, in some cases, less than 1.2%. The glass component may be substantially free of B₂O₃.

(Y₂O₃ and La₂O₃)

Y₂O₃ and La₂O₃ are component that improves the Young's modulus. However, raw materials of these components are relatively expensive. A sum of an Y₂O₃ content and a La₂O₃ content is, for example, 0 to 0.5%, or even 0 to 0.3%. The upper limit of the sum of the Y₂O₃ content and the La₂O₃ content may be 0.1% or less. The glass component may be substantially free of Y₂O₃ and La₂O₃.

### (Additional Component)

The glass composition may include an additional component other than the above. The additional component the glass composition can include is, for example, SrO, BaO, ZnO, TiO₂, ZrO₂, Fe₂O₃, Cl₂, F₂, SnO₂, CeO₂, P₂O₅, or SO₃. A content of each of these components is, for example, 0 to 5%. The upper limit of the content of each of these components may be 3% or less, 1% or less, or even 0.5% or less. The glass component may be substantially free of the additional component, i.e., a component other than the above-described components from SiO₂ to La₂O₃. A total additional component content may be 7% or less, 5% or less, or even 3% or less. The content of a component that can have different valences in the glass composition is calculated, as is conventional, by assuming that the oxide has a valence specified above. For example, although part of iron oxide is present as FeO in the glass composition, the iron oxide content is calculated and shown as Fe₂O₃.

### <Properties>

In an embodiment of the present invention, the common logarithm log η of the viscosity η of the glass composition at the devitrification temperature thereof is, for example, 2.6 or more. The unit of n is [dPa·s]. Moreover, the present invention includes a technique of improving a glass composition having as high a Young's modulus as, for example, 93 GPa or more. Hereinafter, the log η and the Young's modulus will be described.

### (Log η)

The glass composition having a high log η has been revealed to be suitable for being spun into a glass fiber having a relatively small fiber diameter. The log η is, for example, 2.6 or more. The lower limit of the log η may be 2.7 or more, 2.8 or more, 2.9 or more, 2.93 or more, or, in some cases, 3.0 or more. The upper limit of the log η is not limited to a particular one, and is, for example, 3.4 or less, or even 3.2 or less.

Glass compositions in which the MgO content is high and which is suitable for improving Young's modulus tend to have a small difference between a working temperature suitable for spinning and the devitrification temperature. It is common that spinning a glass composition having a small difference between these temperatures is difficult. In particular, spinning such a glass composition into a glass fiber having a small fiber diameter is difficult. However, such difficulties in spinning can be reduced by controlling the log η.

### (Young's Modulus)

The Young's modulus of the glass composition is, for example, 93 GPa or more. The lower limit of the Young's modulus is 95 GPa or more, 97 GPa or more, 99 GPa or more, or, in some cases, 100 GPa or more. The upper limit of the Young's modulus is not limited to a particular one, and is, for example, 115 GPa or less, or even 110 GPa or less.

### <Examples of Glass Composition>

In an embodiment of the present invention, a glass composition includes:
SiO₂ 50 to 65%;
Al₂O₃ 5 to 26%;
B₂O₃ 0 to 1.6%;
MgO 15 to 30%;
CaO 0 to 8%;
Li₂O 0 to 2.4%; and
Na₂O more than 0.2% and 2.85% or less, wherein
the sum of the Li₂O content, the Na₂O content, and the K₂O content is 0.3 to 3.0%, and
the ratio of the Na₂O content to the sum of the Li₂O content, the Na₂O content, and the K₂O content is 0.2 or more and 0.95 or less.

In another embodiment of the present invention, a glass composition includes:
SiO₂ 50 to 65%;
Al₂O₃ 5 to 26%;
B₂O₃ 0 to 1.6%;
MgO 15 to 30%;
CaO 0 to 8%;
Li₂O 0% or more and less than 3%; and
Na₂O more than 0.2% and less than 3%, wherein
the log η is 2.6 or more.

In yet another embodiment of the present invention, in a glass composition,
the Young's modulus is 93 GPa or more, and
the sum of the Li₂O content, the Na₂O content, and the K₂O content is 0.3 to 3.0%,
the ratio of the Na₂O content to the sum of the Li₂O content, the Na₂O content, and the K₂O content is 0.2 or more and 0.95 or less.

In yet another embodiment of the present invention, in a glass composition,
the sum of the SiO₂ content, the Al₂O₃ content, and the MgO content is more than 90% in mol %,
the common logarithm log η of the viscosity η [dPa·s] at the devitrification temperature is 2.6 or more.

The description of the above components and properties is applied to the glass composition of every embodiment described above as an example.

The glass composition of each of the above embodiments is suitable for manufacturing a glass fiber, particularly a glass fiber having a fiber diameter in the above range. In an embodiment of the present invention, the glass fiber includes the glass composition of any of the above embodiments, or is formed of the glass composition of any of the above embodiments. The glass fiber may be in a form of, for example, at least one selected from the group consisting of a strand, a roving, a yarn, a cloth, a chopped strand, glass wool, and a milled fiber. The cloth is, for example, a roving cloth or a yarn cloth. Because of its excellent properties, the glass composition of each of the above embodiments can also be used as a shaped glass product other than the glass fiber. An example of the shaped glass product is a glass particle. The glass particle can be manufactured by breaking the glass fiber or by using, as for the glass fiber, a nozzle having a shape corresponding to an intended shape. Therefore, the glass composition of each of the above embodiments is also suitable for manufacturing the glass particle without devitrification. In one embodiment of the present invention, the glass particle includes the glass composition of any of the above embodiments or is formed of the glass composition of any of the above embodiments.

The glass particle may be, for example, an equivalent of at least one selected from the group consisting of a glass flake, a glass powder, a glass bead, and a fine flake. The glass particle can be included in FRPs. In other words, the glass particle can be used, for example, for reinforcement of a reinforced body typically formed of a resin.

### [Non-Woven Fabric, Rubber-Reinforcing Cord]

Each glass fiber provided by the present invention can be used in the same applications as conventional glass fibers. In one embodiment of the present invention, a non-woven glass fiber fabric including the glass fiber is provided. In another embodiment of the present invention, a rubber-reinforcing cord including a strand formed of a bundle of the glass fibers is provided. The glass fiber can also be used in other applications. Examples of the other applications include reinforcement of a reinforced body typically formed of a resin.

### Examples

Hereinafter, the embodiments of the present invention will be described in more detail by Examples and Comparative Examples. The contents of components in each composition are expressed in mol % also in Tables 1 to 3.

### <Glass Compositions Having Compositions a to H and W to Z>

Common glass raw materials such as silica sand were blended according to each composition shown in Table 1 to prepare glass raw material batches for Examples and Comparative Examples. Each batch was molten by heating it to 1500 to 1600° C. using an electric furnace, and was kept molten for about 4 hours until the composition became uniform. After that, part of the molten glass (glass melt) was poured onto an iron plate, and was slowly cooled to room temperature in an electric furnace. A glass composition (sheet-shaped body; glass specimen) as a bulk was obtained in this manner. Properties of thus-obtained glass compositions were evaluated as follows. Table 1 also shows the results.

### (Devitrification Temperature)

Each glass composition crushed to a particle diameter of 1.0 to 2.8 mm was put in a platinum boat. The glass composition in the boat was left in an electric furnace with a temperature gradient (800 to 1400° C.) for two hours. The devitrification temperature of the glass composition was determined from the maximum temperature of the electric furnace at a position where a crystal appeared. In the case where the glass turned cloudy and no crystal was able to be observed, the maximum temperature of the electric furnace at a position where cloudiness appeared was defined as the devitrification temperature. Here, the particle diameter is a value measured by sieving. It should be noted that varying temperatures at different places in the electric furnace (temperature distribution in the electric furnace) were measured in advance, and the glass composition placed at a given place in the electric furnace was heated at the temperature measured in advance for the given place.

### (Viscosity at Devitrification Temperature)

For each obtained glass composition, the viscosity η at the devitrification temperature was measured by a common platinum ball-drawing method, and the log η was calculated from the measured value.

### (Young's Modulus)

The Young's modulus of each glass composition was determined using an equation E=3ρ·vₜ²·(vₗ²−4/3·vₜ²)/(vₗ²−vₜ²). A longitudinal wave velocity vl and a transverse wave velocity vt were measured by a common ultrasonic method for an elastic wave propagating through the glass. A density ρ was separately measured for the glass by Archimedes' principle.

### <Spinning Test>

Each of the glass compositions having Compositions A to E and W to Z was subjected to a spinning test in which a melt was spun using a platinum nozzle.

The spinning test results were evaluated according to the following criteria. Table 2 shows the results.
∘: A long-term steady spinning is able to be performed, which indicates a sufficient manufacturability.
Δ: Spinning is able to be performed for 10 minutes or longer, but a long-term steady spinning fails.
×1: The platinum nozzle used gets clogged due to devitrification.
×2: The molten glass has too low a viscosity to be spun.

### <Adjustment of Alkali Metal Oxides>

Glass compositions were produced using Compositions C1 and C2 and Compositions D1 to D4, which are based on Compositions C and D and in which only the total alkali metal oxide contents are different from those in Compositions C and D, in the same manner as described above, and were evaluated for their properties. Table 3 shows the compositions and the results.

As shown in Table 2, it has been confirmed that the common logarithm log η of Compositions W and X are so small that Compositions W and X are inappropriate for spinning a fiber having a fiber diameter of 18 μm or less. Spinning itself failed for Compositions Y and Z. On the other hand, it has been confirmed that spinning of the Compositions A to E having a common logarithm log η of 2.6 or more can be favorably achieved even into a small diameter fiber. As shown in Table 3, the closer the Na₂O ratio (molar ratio Na₂O/R₂O) is to approximately 0.5, the greater the common logarithm log η is. It is understood that the Na₂O ratio appropriate for achieving a common logarithm log η of 2.6 or more is 0.2 to 0.95, or even 0.2 to 0.8. However, as can be seen from Composition W in Table 1, in the case of a composition in which the total alkali metal oxide (R₂O) content is too small, adjustment of the Na₂O ratio does not make a great contribution to an increase in common logarithm log η. It should be noted that although slightly lower than those of Compositions W to Z, the Young's moduli of Compositions A to H are sufficiently high compared to those of general-purpose glass fiber compositions.

The working temperatures of the glasses A to H are in the range of 1268 to 1356° C. The difference between the working temperature and the devitrification temperature is less than 60ºC for the glasses A to H. The same applies to the glasses D2 to D4. It should be noted that the working temperature is a temperature at which the common logarithm log η is 3.0.

TABLE 1

| Composition/ | | | | | | | | | | | | |
|---|---|---|---|---|---|---|---|---|---|---|---|---|
| Properties | A | B | C | D | E | F | G | H | W | X | Y | Z |
| SiO₂ | 62.0 | 57.5 | 57.5 | 55.0 | 60.0 | 61.0 | 62.0 | 60.0 | 52.43 | 54.84 | 54.92 | 57.35 |
| Al₂O₃ | 16.0 | 12.5 | 12.5 | 14.5 | 12.0 | 13.5 | 15.5 | 15.0 | 12.48 | 14.96 | 14.98 | 14.96 |
| B₂O₃ | 1.0 | 1.0 | 1.0 | 1.5 | 0.1 | 1.1 | 1.0 | 1.0 | 0.00 | 1.20 | | 1.00 |
| MgO | 16.0 | 24.0 | 24.5 | 23.0 | 26.0 | 22.5 | 20.0 | 22.0 | 24.97 | 27.52 | 24.96 | 25.43 |
| CaO | 3.0 | 4.0 | 4.0 | 5.0 | 1.0 | 1.0 | 0.5 | 1.0 | 9.99 | 0.17 | 4.99 | 0.15 |
| Li₂O | 1.0 | 0.45 | 0.25 | 0.5 | 0.5 | 0.5 | 0.5 | 0.5 | | 1.20 | | 1.00 |
| Na₂O | 1.0 | 0.45 | 0.25 | 0.6 | 0.5 | 0.5 | 0.5 | 0.5 | 0.03 | 0.05 | 0.08 | 0.05 |
| K₂O | | 0.1 | 0.02 | 0.1 | | | | | 0.01 | 0.01 | | 0.01 |
| R₂O | 2.0 | 1.0 | 0.52 | 1.1 | 1.0 | 1.0 | 1.0 | 1.0 | 0.04 | 1.26 | 0.08 | 1.06 |
| Na₂O/R₂O | 0.50 | 0.45 | 0.48 | 0.50 | 0.50 | 0.50 | 0.50 | 0.50 | 0.75 | 0.04 | 1.00 | 0.047 |
| Devitrification | 1327 | 1275 | 1331 | 1295 | 1372 | 1332 | 1327 | 1320 | 1280 | 1345 | 1395 | 1400 |
| temperature | | | | | | | | | | | | |
| (° C.) | | | | | | | | | | | | |
| logη | 3.20 | 2.95 | 2.93 | 2.90 | 2.66 | 2.94 | 3.13 | 3.04 | 2.55 | 2.47 | 2.18 | 2.15 |
| Young's | 94.0 | 99.5 | 100.2 | 100.2 | 99.5 | 99.1 | 99.4 | 99.8 | 102.4 | 101.8 | 102.7 | 101.9 |
| modulus (GPa) | | | | | | | | | | | | |

TABLE 2

| | | | | | | Fiber | Spinning | |
|---|---|---|---|---|---|---|---|---|
| | | | | | | diameter | rate | Spinning |
| | Composition | logη | MgO | R₂O | Na₂O/R₂O | (μm) | (rpm) | ability |
| Example 1 | A | 3.20 | 16.0 | 2.0 | 0.50 | 7 | 2700 | ∘ |
| Example 2 | A | 3.20 | 16.0 | 2.0 | 0.50 | 13 | 850 | ∘ |
| Example 3 | A | 3.20 | 16.0 | 2.0 | 0.50 | 18 | 450 | ∘ |
| Example 4 | B | 2.95 | 24.0 | 1.0 | 0.45 | 7 | 2700 | ∘ |
| Example 5 | B | 2.95 | 24.0 | 1.0 | 0.45 | 13 | 850 | ∘ |
| Example 6 | B | 2.95 | 24.0 | 1.0 | 0.45 | 18 | 450 | ∘ |
| Example 7 | C | 2.93 | 24.5 | 0.5 | 0.48 | 7 | 2700 | ∘ |
| Example 8 | C | 2.93 | 24.5 | 0.5 | 0.48 | 13 | 850 | ∘ |
| Example 9 | C | 2.93 | 24.5 | 0.5 | 0.48 | 18 | 450 | ∘ |
| Example 10 | D | 2.90 | 23.0 | 1.1 | 0.50 | 7 | 2700 | ∘ |
| Example 11 | D | 2.90 | 23.0 | 1.1 | 0.50 | 13 | 850 | ∘ |
| Example 12 | D | 2.90 | 23.0 | 1.1 | 0.50 | 18 | 450 | ∘ |
| Example 13 | E | 2.66 | 26.0 | 1.0 | 0.50 | 7 | 3080 | ∘ |
| Example 14 | E | 2.66 | 26.0 | 1.0 | 0.50 | 13 | 950 | ∘ |
| Example 15 | E | 2.66 | 26.0 | 1.0 | 0.50 | 18 | 500 | ∘ |
| Comparative | W | 2.55 | 25.0 | 0.04 | 0.75 | 7 | 2300 | x2 |
| Example 1 | | | | | | | | |
| Comparative | W | 2.55 | 25.0 | 0.04 | 0.75 | 13 | 700 | x1 |
| Example 2 | | | | | | | | |
| Comparative | W | 2.55 | 25.0 | 0.04 | 0.75 | 18 | 400 | Δ |
| Example 3 | | | | | | | | |
| Comparative | W | 2.55 | 25.0 | 0.04 | 0.75 | 23 | 300 | ∘ |
| Example 4 | | | | | | | | |
| Comparative | X | 2.47 | 27.5 | 1.26 | 0.04 | 7 | 3080 | x2 |
| Example 5 | | | | | | | | |
| Comparative | X | 2.47 | 27.5 | 1.26 | 0.04 | 13 | 850 | x1 |
| Example 6 | | | | | | | | |
| Comparative | X | 2.47 | 27.5 | 1.26 | 0.04 | 18 | 450 | Δ |
| Example 7 | | | | | | | | |
| Comparative | X | 2.47 | 27.5 | 1.26 | 0.04 | 23 | 300 | ∘ |
| Example 8 | | | | | | | | |
| Comparative | Y | 2.18 | 25.0 | 0.08 | 1.00 | 23 | 300 | x2 |
| Example 9 | | | | | | | | |
| Comparative | Z | 2.15 | 25.4 | 1.06 | 0.047 | 23 | 300 | x2 |
| Example10 | | | | | | | | |

x1: Clogged due to devitrification
x2: Not being spun into a thread

TABLE 3

| Composition/ | | | | | | | | |
|---|---|---|---|---|---|---|---|---|
| Properties | C1 | C | C2 | D1 | D2 | D | D3 | D4 |
| SiO₂ | 57.5 | 57.5 | 57.5 | 55.0 | 55.0 | 55.0 | 55.0 | 55.0 |
| Al₂O₃ | 12.5 | 12.5 | 12.5 | 14.5 | 14.5 | 14.5 | 14.5 | 14.5 |
| B₂O₃ | 1.0 | 1.0 | 1.0 | 1.5 | 1.5 | 1.5 | 1.5 | 1.5 |
| MgO | 24.5 | 24.5 | 24.5 | 23.0 | 23.0 | 23.0 | 23.0 | 23.0 |
| CaO | 4.0 | 4.0 | 4.0 | 5.0 | 5.0 | 5.0 | 5.0 | 5.0 |
| Li₂O | 0.5 | 0.25 | 0.00 | 0.90 | 0.75 | 0.5 | 0.3 | 0.1 |
| Na₂O | | 0.25 | 0.50 | 0.10 | 0.25 | 0.6 | 0.8 | 1.0 |
| K₂O | | 0.02 | 0.02 | 0.10 | 0.10 | 0.1 | 0.1 | 0.1 |
| R₂O | 0.5 | 0.52 | 0.52 | 1.10 | 1.10 | 1.1 | 1.1 | 1.1 |
| Na₂O/R₂O | 0.00 | 0.48 | 0.96 | 0.09 | 0.23 | 0.50 | 0.68 | 0.86 |
| Devitrification | 1360 | 1331 | 1378 | 1312 | 1308 | 1295 | 1317 | 1340 |
| temperature | | | | | | | | |
| (° C.) | | | | | | | | |
| logη | 2.50 | 2.93 | 2.41 | 2.53 | 2.72 | 2.90 | 2.74 | 2.62 |
| Young's | 100.5 | 100.2 | 100.4 | 100.7 | 100.5 | 100.2 | 100.2 | 100.3 |
| modulus (GPa) | | | | | | | | |

1-36. (canceled)

37. A glass composition for glass fibers, the glass composition comprising, in mol %:
SiO₂ 50 to 65%;
Al₂O₃ 5 to 26%;
B₂O₃ 0 to 1.6%;
MgO 20 to 30%;
CaO 0 to 6%;
Li₂O 0.1 to 0.8%; and
Na₂O more than 0.2% and 2.85% or less, wherein
a sum of a Li₂O content, a Na₂O content, and a K₂O content is 0.5 to 3.0%,
a Na₂O ratio defined by a ratio of the Na₂O content to the sum of the Li₂O content, the Na₂O content, and the K₂O content is 0.2 or more and 0.95 or less, and
a sum of an Y₂O₃ content and a La₂O₃ content in the glass composition is 0 to 0.5%.

38. The glass composition according to claim 37, wherein a sum of a SiO₂ content, an Al₂O₃ content, and a MgO content is more than 90% in mol %.

39. The glass composition according to claim 37, wherein a B₂O₃ content is 0.1 to 1.6% in mol %.

40. The glass composition according to claim 39, wherein a SiO₂ content is 57 to 62% in mol %.

41. The glass composition according to claim 37, wherein
a SiO₂ content is 52 to 62% in mol %, and
an Al₂O₃ content is 7.5 to 26% in mol %.

42. The glass composition according to claim 41, wherein the Al₂O₃ content is 9 to 26% in mol %.

43. The glass composition according to claim 42, wherein, in mol %,
the SiO₂ content is 55 to 62%, and
the Al₂O₃ content is 10.5 to 17.5%.

44. The glass composition according to claim 43, wherein, in mol %,
the Al₂O₃ content is 11 to 17.5%.

45. The glass composition according to claim 37, wherein the glass composition is substantially free of Y₂O₃.

46. The glass composition according to claim 37, wherein
a common logarithm log η of a viscosity η [dPa·s] of the glass composition at a devitrification temperature is 2.6 or more, and
the Young's modulus is 99 GPa or more.

47. A glass composition for glass fibers, comprising, in mol %:
SiO₂ 50 to 65%;
Al₂O₃ 5 to 26%;
B₂O₃ 0 to 1.6%;
MgO 20 to 30%;
CaO 0 to 6%;
Li₂O 0.1 to 0.8%; and
Na₂O more than 0.2% and less than 3%, wherein
a common logarithm log η of a viscosity η [dPa·s] at a devitrification temperature is 2.6 or more, and the Young's modulus is 99 GPa or more.

48. The glass composition according to claim 47, wherein the log η is 2.7 or more.

49. The glass composition according to claim 47, wherein the glass composition is substantially free of Y₂O₃.

50. The glass composition according to claim 47, wherein a Na₂O ratio defined by a ratio of the Na₂O content to the sum of the Li₂O content, the Na₂O content, and the K₂O content is 0.2 or more and 0.95 or less in mol %.

51. A glass fiber, comprising the glass composition according to claim 37.

52. The glass fiber according to claim 51, having a fiber diameter of 18 μm or less.

53. The glass fiber according to claim 51, being in a form of at least one selected from the group consisting of a strand, a roving, a yarn, a cloth, a chopped strand, glass wool, and a milled fiber.

54. A rubber-reinforcing cord, comprising a strand formed of a bundle of a plurality of the glass fibers according to claim 51.

55. A glass fiber non-woven fabric, comprising the glass fiber according to claim 51.

56. A glass particle comprising a glass composition, the glass composition comprising, in mol %:
SiO₂ 50 to 65%;
Al₂O₃ 5 to 26%;
B₂O₃ 0 to 1.6%;
MgO 20 to 30%;
CaO 0 to 6%;
Li₂O 0.1 to 0.8%; and
Na₂O more than 0.2% and 2.85% or less, wherein
a sum of a Li₂O content, a Na₂O content, and a K₂O content is 0.5 to 3.0%,
a Na₂O ratio defined by a ratio of the Na₂O content to the sum of the Li₂O content, the Na₂O content, and the K₂O content is 0.2 or more and 0.95 or less, and
a sum of an Y₂O₃ content and a La₂O₃ content is 0 to 0.5% in mol %.

57. A glass particle comprising a glass composition, the glass composition comprising, in mol %:
SiO₂ 50 to 65%;
Al₂O₃ 5 to 26%;
B₂O₃ 0 to 1.6%;
MgO 20 to 30%;
CaO 0 to 6%;
Li₂O 0.1 to 0.8%; and
Na₂O more than 0.2% and less than 3%, wherein
a common logarithm log η of a viscosity η [dPa·s] at a devitrification temperature is 2.6 or more, and the Young's modulus is 99 GPa or more.
